(19) United States
(12) Patent Application Publication
(10) Pub. No.: US 2024/0036920 A1
(43) Pub. Date: Feb. 1, 2024

(54) METHOD AND SYSTEM FOR PRIORITY-BASED RESOURCE SCHEDULING WITH LOAD BALANCING

(71) Applicants: Waterlabs AI LLC, Wilmington, DE (US); Waterlabs AI Technologies Private Limited, Bengaluru (IN)

(72) Inventor: KAMALRAJ CHANDRASEKARAN, Bengaluru (IN)

(21) Appl. No.: 18/361,688

(22) Filed: Jul. 28, 2023

(30) Foreign Application Priority Data
Jul. 30, 2022 (IN) 202211043744

(51) Int. Cl. G06F 9/48; G06F 9/50; G06F 9/455

(52) U.S. Cl. CPC G06F 9/4881; G06F 9/4856; G06F 9/5038; G06F 9/505; G06F 9/45558; G06F 2009/4557

(57) ABSTRACT

Present disclosure generally relates to resource scheduling systems, more particularly relates to a method and a system for priority-based resource scheduling with load balancing. A method includes receiving, from client devices, client requests to execute tasks on servers associated with one or more Virtual Machines (VMs). Further, method includes determining usage-related information of each server, upon receiving client requests. Furthermore, method includes prioritizing received client requests, based on request parameters associated with client requests. Further, method includes assigning computing resources in servers to execute tasks for client devices using dynamic programming technique. The method includes monitoring dynamically, usage-related information of servers. Further, method includes migrating from first server to second server of servers, tasks using round-robin technique and/or graph theory technique, based on usage-related information. Furthermore, method includes initiating tasks on second server, in response to migrating the one or more tasks.

### CROSS REFERENCE TO RELATED APPLICATIONS

The present application claims benefit of priority from Indian Patent Application No. IN 202211043744 filed on Jul. 30, 2022, the entirety of which is expressly incorporated herein by reference.

### FIELD OF THE INVENTION

The present technology generally relates to resource scheduling systems. More particularly, the present technology relates to a method and a system for priority-based resource scheduling with load balancing.

### BACKGROUND OF THE DISCLOSURE

The background description includes information that may be useful in understanding the present invention. It is not an admission that any of the information provided herein is prior art or relevant to the presently claimed invention, or that any publication specifically or implicitly referenced is prior art.

Generally, in a multi-tenant environment where multiple tenants or users may concurrently execute tasks on a same computing device, virtualization technologies can be used to provide each tenant with one or more virtual machines that act as discrete computing units within the same computing device. Each virtual machine may have its own dedicated computing resources allocated to the corresponding tenant. However, because each tenant may implement different services or functionalities on the same computing device, the amounts and types of computing resources that may be required by each tenant can be different and may change over time. Conventional methods for performing large-scale computational jobs often required a user to actively manage tenants in a distributed environment and to manage queues for the jobs. This active involvement of the user may inhibit the ability of the job to span large resource clusters and to scale the use of those clusters in an efficient manner. Further, jobs may conventionally be created in a manner that the job, the resources used for completing the job, and the scheduling of the job on the resources are tightly coupled to prevent efficient migration of the job in response to a failure or load balancing.

Further, the use of Virtual Machines (VMs) in computing platform continues to increase, and the storage-related demands of such VMs have fostered development and deployment of distributed storage systems. Currently, the distributed storage systems may have evolved to include autonomous nodes that facilitate scaling to virtually any speed or capacity. In some cases, the distributed storage systems can include numerous nodes supporting multiple user VMs running a broad variety of applications, tasks, and/or processes. For example, in clusters that may host hundreds or thousands (or more) autonomous VMs, the storage I/O (input/output or IO) activity in the distributed storage system can be highly dynamic. With such large-scale, highly dynamic distributed storage systems, certain management tasks (e.g., background tasks) may be executed to maintain a uniform and/or consistent performance level as may be demanded by a Service Level Agreement (SLA) and/or as is expected by the users. Such management tasks might include tasks related to data replication (e.g., for disaster recovery, data protection policies, and the like), data movement (e.g., for disk balancing, Information Lifecycle Management (ILM), and the like.), data compression, and/or other processes. Execution of management tasks often improves the performance level of the system. Even though users recognize that management tasks necessarily consume cluster resources (e.g., nodes, CPU time, I/O, etc.), and even though the user of the distributed storage system might recognize the benefits facilitated by the execution of management tasks, the users do not want to experience reduced system performance. Further, a specific set of tasks, and corresponding task schedule (e.g., launched sequence), associated with a scan might be pre-determined in certain conventional methods. Such conventional methods can conflict with a particular user storage I/O characteristic occurring at the time the management tasks are executed. Further, a management task that is scheduled to use resources (e.g., nodes, paths, storage devices, etc.) used by one or more user VMs can impact the performance at those user VMs.

Conventional methods may provide a method for auto-scaling of servers based on task requests waiting in queues. The conventional method may assign incoming job requests to resources equally by using a load balancer in such a way that resources are utilized effectively and save energy. Another conventional method may provide a cloud service that is aggregated from private server farms for the purpose of large computational jobs. Clients submit jobs with labels of quality-of-service information that may include a priority. Another conventional provides systems and/or methods that facilitate dynamically allocating resources (e.g., hardware, software) supported by a third-party service provider. Yet another conventional method may provide a cloud computation data centre method for scheduling tasks based on graph theory for improving cloud computing platform resource utilization and reducing energy consumption. Another conventional method may provide a cloud platform job scheduling method. The conventional method may include distributing and updating time slots according to a quota value of a virtual machine where real-time operation is performed, the scheduling priority of the virtual machine where real-time operation is performed is improved, and the scheduling period of the virtual machine is adjusted according to time quantum. Another conventional method may provide a task scheduling method for maximizing MapReduce cluster energy consumption. By adopting the task scheduling method, the total running time of the cluster is shortened to lower the energy consumption. Further, another conventional method may provide a cloud platform service trust value computing, task scheduling, and load balancing methods. The conventional method provides trust value calculation, task scheduling and load balancing, determining the influence of trust attack of a malicious service candidate on task scheduling, considering the balance between system benefit and energy consumption, improving a cloud task scheduling efficiency, and reducing the attack of a malicious service provider on the cloud platform. Yet another conventional method provides a method for minimizing the operational cost of data centres via geographical electricity price diversity. The conventional method incorporates a diversity of time-varying electricity prices in different regions, to fairly allocate requests to different data centres for processing while keeping the negotiated Service Level Agreements (SLAs) between request users and the cloud service provider to be met.

However, the conventional methods may not handle skewness in scheduling mechanism for priority-based task scheduling. To avoid skewness the conventional methods may not update time-based server utilization for the scheduler. Further, the conventional methods may not handle/avoid speculative execution in load balancing for resource utilization. Furthermore, the conventional methods may not use dynamic programming technique for client/tenant prioritization and task scheduling. As a result, in many cases, excess computing resources may be scheduled leading to inefficient utilization of resources, and in other cases, uncertainty may lead to insufficient scheduling of resources, which in turn, may lead to over utilization of scheduled resources, performance degradation, and/or service interruption.

Hence, there is a need in the state of the art to provide the system and method for method and a system for priority-based resource scheduling with load balancing which overcomes above-mentioned and other limitations of existing approaches.

### SUMMARY OF THE INVENTION

The present technology provides a method for priority-based resource scheduling with load balancing. The method includes receiving, from a plurality of client devices, one or more client requests to execute one or more tasks on one or more servers associated with one or more Virtual Machines (VMs). The one or more client requests comprises request parameters. Further, the method includes determining usage-related information of each server associated with one or more VMs, upon receiving the one or more client requests. Furthermore, the method includes prioritizing the received one or more client requests, based on the request parameters associated with the one or more client requests. Further, the method includes assigning computing resources in the one or more servers to execute one or more tasks for the one or more client devices using a dynamic programming technique, based on the determined usage-related information and the prioritized one or more client requests. Additionally, the method includes monitoring dynamically, the usage-related information of the one or more servers. Further, the method includes migrating from a first server to a second server of the one or more servers, the one or more tasks using at least one of a round-robin technique and graph theory technique, based on the monitored usage-related information. The first server is executing the one or more tasks for the one or more client devices. Furthermore, the method includes initiating the one or more tasks on the second server, in response to migrating the one or more tasks.

In an aspect, the request parameters include at least one of a demand comprising several tasks, a timeline, a pricing category, and a Service Level Agreements (SLAs).

In another aspect, the usage-related information includes at least one of an active time, a running time, and a load level.

In yet another aspect, the graph theory comprises K-colour set problem technique which is used for task scheduling.

In yet another aspect, the round-robin technique is used for time-based server utilization, based on a round-robin time scheduler report provided by the round-robin technique.

In another aspect, the round-robin technique and the dynamic programming technique are used to prioritize Service Level Agreements (SLA) requirements of the one or more client devices.

Further, the present technology provides a resource scheduling system for priority-based resource scheduling with load balancing. The resource scheduling system receives, from a plurality of client devices, one or more client requests to execute one or more tasks on one or more servers associated with one or more Virtual Machines (VMs). The one or more client requests comprises request parameters. Further, the resource scheduling system determines usage-related information of each server associated with one or more VMs, upon receiving the one or more client requests. Furthermore, the resource scheduling system prioritizes the received one or more client requests, based on the request parameters associated with the one or more client requests. Furthermore, the resource scheduling system assigns computing resources in the one or more servers to execute one or more tasks for the one or more client devices using a dynamic programming technique, based on the determined usage-related information and the prioritized one or more client requests. Additionally, the resource scheduling system monitors dynamically, the usage-related information of the one or more servers. Further, the resource scheduling system migrates from a first server to a second server of the one or more servers, the one or more tasks using at least one of a round-robin technique and graph theory technique, based on the monitored usage-related information. The first server is executing the one or more tasks for the one or more client devices. Furthermore, the resource scheduling system initiates the one or more tasks on the second server, in response to migrating the one or more tasks.

Various objects, features, aspects, and advantages of the present technology will become more apparent from the following detailed description of preferred embodiments, along with the accompanying drawing figures in which like numerals represent like features.

Within the scope of this application, it is expressly envisaged that the various aspects, embodiments, examples, and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

The present technology provides a method and system for priority-based resource scheduling with load balancing.

The present technology solves a speculative execution problem to sort the Virtual Machine (VM) or cluster failure problem and improves the reliability in process functioning, by using the colour set problem in graph theory for task scheduling.

The present technology provides a method and system for scheduling one or more tasks using a dynamic programming approach initially, and from the second round, for scheduling one or more tasks a Round Robin time scheduler report may be considered. The Round Robin approach may be used for updating time-based server utilization for a dynamic scheduler to avoid skewness.

The present technology uses a dynamic programming approach and Round Robin time scheduler report to ease the prioritization of Service Level Agreements (SLA) requirements.

The present technology uses a dynamic scheduler that can improve the factors related to latency and efficient SLA prioritization.

Some of the objects of the present disclosure, which at least one embodiment herein satisfies, are as listed herein below.

An object is to provide a method and system for priority-based resource scheduling with load balancing.

Another object is to solve a speculative execution problem to sort the Virtual Machine (VM) or cluster failure problem and improve the reliability in process functioning, by using a colour set problem in graph theory for task scheduling.

Another object is to provide a method and system for scheduling one or more tasks using a dynamic programming approach initially, and from the second round, for scheduling one or more tasks a Round Robin time scheduler report may be considered. The Round Robin approach is used for updating time-based server utilization for a dynamic scheduler to avoid skewness.

Yet another object is to use a dynamic programming approach and Round Robin time scheduler report to ease the prioritization of Service Level Agreements (SLA) requirements.

Yet another object is to use a dynamic scheduler that can improve the factors related to latency and efficient SLA prioritization.

It is therefore an object to provide a method for priority-based resource scheduling with load balancing, the method comprising: receiving, by a processor (202) associated with a resource scheduling system (110), from a plurality of client devices (104), one or more client requests to execute one or more tasks on one or more servers (116) associated with one or more Virtual Machines (VMs), wherein the one or more client requests comprises request parameters; determining, by the processor (202), usage-related information of each server associated with one or more VMs, upon receiving the one or more client requests; prioritizing, by the processor (202), the received one or more client requests, based on the request parameters associated with the one or more client requests; assigning, by the processor (202), computing resources in the one or more servers (116) to execute one or more tasks for the one or more client devices (104) using a dynamic programming technique, based on the determined usage-related information and the prioritized one or more client requests; monitoring dynamically, by the processor (202), the usage-related information of the one or more servers (116); migrating, by the processor (202), from a first server to a second server of the one or more servers (116), the one or more tasks using at least one of a round-robin technique and graph theory technique, based on the monitored usage-related information, wherein the first server is executing the one or more tasks for the one or more client devices (104); and initiating, by the processor (202), the one or more tasks on the second server, in response to migrating the one or more tasks, wherein initiating the one or more tasks on the second server is to balance a load for resource utilization of the first server and the second server.

It is also an object to provide a resource scheduling system (110) for priority-based resource scheduling with load balancing, the method comprising: a processor (202); a memory (206) coupled to the processor (202), wherein the memory (206) comprises processor-executable instructions, which on execution causes the processor (202) to: receive, from a plurality of client devices (104), one or more client requests to execute one or more tasks on one or more servers (116) associated with one or more Virtual Machines (VMs), wherein the one or more client requests comprises request parameters; determine usage-related information of each server associated with one or more VMs, upon receiving the one or more client requests; prioritize the received one or more client requests, based on the request parameters associated with the one or more client requests; assign computing resources in the one or more servers (116) to execute one or more tasks for the one or more client devices (104) using a dynamic programming technique, based on the determined usage-related information and the prioritized one or more client requests; monitor dynamically, the usage-related information of the one or more servers (116); migrate from a first server to a second server of the one or more servers (116), the one or more tasks using at least one of a round-robin technique and graph theory technique, based on the monitored usage-related information, wherein the first server is executing the one or more tasks for the one or more client devices (104); and initiate the one or more tasks on the second server, in response to migrating the one or more tasks, wherein initiating the one or more tasks on the second server is to balance a load for resource utilization of the first server and the second server.

It is a further object to provide a system for priority-based resource scheduling with load balancing, comprising: an input port configured to receive requests to execute one or more tasks; at least one automated processor (202) associated with a resource scheduling system (110), configured to: receive from a plurality of client devices (104), one or more client requests to execute one or more tasks on one or more servers (116) associated with one or more Virtual Machines (VMs), wherein the one or more client requests comprises request parameters; determine usage-related information of each server associated with one or more VMs, upon receiving the one or more client requests; prioritize the received one or more client requests, based on the request parameters associated with the one or more client requests; assign computing resources in the one or more servers (116) to execute one or more tasks for the one or more client devices (104) using a dynamic programming technique, based on the determined usage-related information and the prioritized one or more client requests; dynamically monitor the usage-related information of the one or more servers (116); migrate the one or more tasks from a first server to a second server of the one or more servers (116) using at least one of a round-robin technique and graph theory technique, based on the monitored usage-related information, wherein the first server executes the one or more tasks for the one or more client devices (104); and initiate the one or more tasks on the second server, in response to migrating the one or more tasks, wherein the one or more tasks are initiated on the second server to balance a load for resource utilization of the first server and the second server; and an output port configured communicate control information the first server and the second server.

The at least one automated processor may be configured to migrate the one or more tasks from a first server to a second server of the one or more servers (116) using a round-robin technique.

The at least one automated processor may be configured to migrate the one or more tasks from a first server to a second server of the one or more servers (116) a graph theory technique.

The request parameters may comprise at least one of a demand comprising several tasks, a timeline, a pricing category, and a Service Level Agreement (SLA).

The usage-related information may comprises at least one of an active time, a running time, and a load level.

The graph theory may comprises K-colour set problem technique which is used for task scheduling.

The round-robin technique is used for time-based server utilization, is based on a round-robin time scheduler report provided by the round-robin technique.

The round-robin technique and the dynamic programming technique may be used to prioritize Service Level Agreement (SLA) requirements of the one or more client devices (104).

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure, and wherein:

FIG. 1 illustrates an exemplary block diagram representation of network architecture in which or with which proposed system of the present disclosure can be implemented, in accordance with an embodiment of the present disclosure.

FIG. 2 illustrates a detailed block diagram representation of a system for priority-based resource scheduling with load balancing, in accordance with an embodiment of the present disclosure.

FIG. 3A illustrates a flow diagram representation of a client-server interaction for priority-based resource scheduling with load balancing, in accordance with an embodiment of the present disclosure.

FIG. 3B illustrates a flow diagram representation of a utilization status of server of Virtual Machine (VM), in accordance with an embodiment of the present disclosure.

FIG. 4 illustrates a flow chart depicting a method for priority-based resource scheduling with load balancing, in accordance with an embodiment of the present disclosure.

FIG. 5 illustrates an exemplary computer system in which or with which embodiments of the present invention can be utilized, in accordance with embodiments of the present disclosure.

### DETAILED DESCRIPTION OF THE PREFERRED EMBODIMENTS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition persons in the pertinent art have given that term as reflected in printed publications and issued patents at the time of filing.

Various embodiments disclosed herein provide a method and system for priority-based resource scheduling with load balancing. The present disclosure solves a speculative execution problem to sort the Virtual Machine (VM) or cluster failure problem and improve the reliability in process functioning, by using colour set problem in graph theory for task scheduling. The present disclosure provides a method and system for scheduling one or more tasks using dynamic programming approach initially, and from the second round, for scheduling one or more tasks a Round Robin time scheduler report may be considered. The Round Robin approach is used for updating time-based server utilization for a dynamic scheduler to avoid skewness. The present disclosure uses dynamic programming approach and Round Robin time scheduler report to ease the prioritization of Service Level Agreements (SLA) requirements. The present disclosure uses a dynamic scheduler that can improve the factors related to latency and efficient SLA prioritization.

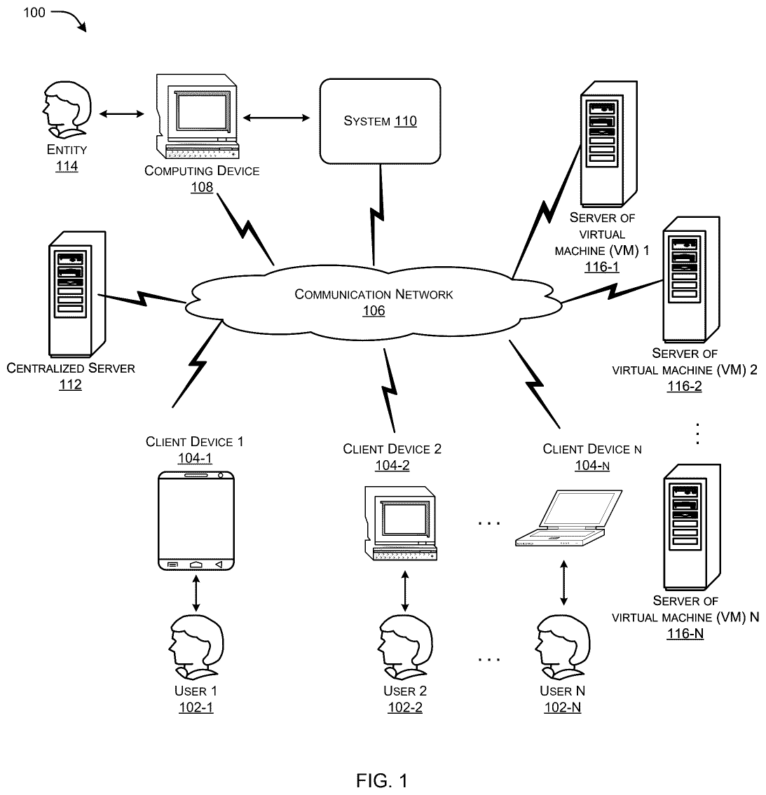

Referring to FIG. 1 illustrating an exemplary block diagram representation of a network architecture for priority-based resource scheduling with load balancing system 100 (also referred to as the network architecture 100) in which or with which a proposed system 110 (also referred to as resource scheduling system 110) of the present disclosure can be implemented, in accordance with an embodiment of the present disclosure. As illustrated, the exemplary network architecture 100 may be equipped with the system 110 for priority-based resource scheduling with load balancing to one or more users 102-1, 102-2, 102-3, . . . , 102-N (individually referred to as the user 102 and collectively referred to as the users 102) associated with one or more client devices 104-1, 104-2, . . . , 104-N (individually referred to as the client device 104 and collectively referred to as the client devices 104). The users 102 may be at least one of, but not limited to, an individual user, and the like.

In an embodiment, the system 110 may be communicatively and/or operatively coupled to a computing device 108 (individually referred to as the computing device 108 and collectively referred to as the computing devices 108). The system 110 may also be associated with the computing device 108. The computing device 108 may be associated with at least one of, but not limited to, a company, an office, an organization, a university, a lab facility, a business enterprise, a firm, a bank, a consumer, a merchant, an investor, a store, a gaming facility, a gaming zone, an e-commerce platform, a delivery platform, a courier platform, or any other secured facility, a buyer or a seller platform, a customer service platform, an educational institution, a service provider, a software developing platform, and the like. In an embodiment, the one or more client devices 104, and the one or more computing devices 108 may communicate with the system 110 via a set of executable instructions residing on any operating system. In an embodiment, one or more client devices 104, and the one or more computing devices 108 may include, but is not limited to, any electrical, electronic, electro-mechanical or an equipment or a combination of one or more of the above devices such as mobile phones, smartphones, Virtual Reality (VR) devices, Augmented Reality (AR) devices, laptops, a general-purpose computer, desktops, personal digital assistants, tablet computers, mainframe computers, or any other computing devices. Such computing devices may include one or more in-built or externally coupled accessories including, but not limited to, a visual aid device such as camera, audio aid, a microphone, a keyboard, input devices for receiving input from a user such as touch pad, touch-enabled screen, electronic pen, receiving devices for receiving any audio or visual signal in any range of frequencies and transmitting devices that can transmit any audio or visual signal in any range of frequencies. It may be appreciated that, the to one or more client devices 104, and the one or more second computing devices 108 may not be restricted to the mentioned devices and various other devices may be used.

In an embodiment, the system 110 may also be communicatively coupled to the one or more client devices 104 via a communication network 106. The communication network may be a wired or a wireless communication network. In some embodiments, the system 110 may be implemented using an electronic device such as, but is not limited to, a mobile, a smart phone, a tablet, a phablet, a personal digital assistant, a computer, a laptop, a server, and the like. Such server may include or comprise, by way of example, but is not limited to, one or more of a stand-alone server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof. In an embodiment, the system 110 may be a System on Chip (SoC) system but not limited to the like. In another embodiment, an onsite data capture, storage, matching, processing, decision-making, and actuation logic may be coded using Micro-Services Architecture (MSA) but not limited to it. A plurality of microservices may be containerized and may be event based to support portability. In an embodiment, the network architecture 100 may be modular and flexible to accommodate any kind of changes in the system 110 as proximate processing may be acquired towards priority-based resource scheduling with load balancing. The system 110 configuration details can be modified on the fly. In an embodiment, the system 110 may be remotely monitored and the data, application, and physical security of the system 110 may be fully ensured. In an embodiment, the data may get collected meticulously and deposited in a cloud-based data lake to be processed to extract actionable insights. Therefore, the aspect of predictive maintenance can be accomplished. In an exemplary embodiment, the communication network 106 may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network may include, by way of example but not limitation, one or more of: a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, some combination thereof.

Due to increases in the speed of data transmission over networks and improvements in other network features, it is increasingly possible to perform large-scale computing tasks in an environment where computing resources are distributed over a large network. For example, the user 102 in a first location can submit a job or computing task to a computing service and have the task performed on a group of computers or servers to which the user has no direct knowledge. The computing resources for performing the user's task may be distributed over multiple physical locations, which may span different states, countries, and/or continents. A first group of computing resources located in one or more locations can store the data and other information for performing the user's computing task, while a second group of computing resources, in the same locations or possibly in a different set of one or more locations, can be used to perform the computing task. Further, it is contemplated that the one or more locations for storing the data may be dispersed across different geographical regions, with or without knowledge by the user. Similarly, it is contemplated that the computing resources may be dispersed across different geographic locations with or without the user's knowledge. Further, access to a variety of distributed computing resources allows a user to perform job tasks (e.g., running processes) without concern for where the computing resources are located. The distributed resources also provide an opportunity for a user to scale out (or scale in) the amount of resources used to meet goals for a computing task, such as completing the computing task by a specified time or with a desired cost value.

Generally, “virtualization technology” may be used for providing isolation between different operating environments sharing the same physical resources. In other words, virtualization may provide a logical abstraction of computing resources from physical constraints. One common abstraction is referred to as a Virtual Machine (also known as guest), or VM, which provides the content running in the VM a direct interface to the physical hardware while maintaining the abstraction. Generally, virtualization technology allows multiple VMs running on the same physical hardware to operate independently and isolated from each other. The one or more VMs on the system are managed by a Virtualized Machine Monitor, or VMM (also known as hypervisor or host). The VMM is a software or firmware layer responsible for hosting and managing VMs. For example, multiple processing cores may share caches and certain busses on the processor. Furthermore, in some implementations, multiple execution threads may operate on the same thread sharing the execution pipeline and level 1 and level 2 caches.

The network architecture 100 may further include Virtual Machines (VMs) (not shown in FIG. 1). The VMs may include one or more servers 116-1, 116-2, . . . , 116-N (individually referred to as the server 116 and collectively referred to as the servers 116). The system 110 may be communicatively coupled to the servers 116 or the VMs. The VMs may be placed remotely across various geography and/or locally.

In an embodiment, the system 110 may receive, from a plurality of client devices 104, one or more client requests to execute one or more tasks on one or more servers 116 associated with one or more Virtual Machines (VMs). In an embodiment, the one or more client requests comprises request parameters. The request parameters include, but is not limited to, a demand comprising several tasks, a timeline, a pricing category, a Service Level Agreements (SLAs), and the like. Examples of one or more tasks may include, but are not limited to, a processing thread, a process, or an application that may include multiple processes.

In an embodiment, the system 110 may determine usage-related information of each server 116 associated with one or more VMs, upon receiving the one or more client requests. The usage-related information includes, but is not limited to, an active time, a running time, a load level, and the like. Further, the usage-related information may also include, utilization data, expenditure report data for resource reservation/activation, computing resource consumption metric data, activation request data, functional grouping data, topological or relationship data, tagging data, or other metadata. The utilization data, may include, for example, historical data related to usage or activation of cloud computing resources, e.g., resource allocation history, activation/reservation/committed-use history data, expenditure report data for resource reservation/activation/committed-use, processor activity, memory usage history, computing cycles, data throughput, or other utilization metrics, seasonal usage cycles. The seasonal usage cycles may include, for example, holiday schedules, daily usage cycles, weekly usage cycles, quarterly usage cycles, or other data. The tagging data may include computing resource-specific data. For example, tagging data may include data provided by an operator, provisioning or configuration management system, or an analysed system detailing functional groupings (e.g., project-specific allocations, hardware (including virtualized hardware) marked for a specific purpose, availability zones, operating systems), quality of service requirements, minimum allocations, or other tagging data. Further, the consumption metric data may include computing resource-specific cost metrics such as expenditure-per-time or resource-per-time metrics.

In an embodiment, the system 110 may prioritize the received one or more client requests, based on the request parameters associated with the one or more client requests. In an embodiment, the system 110 may assign computing resources in the one or more servers 116 to execute the one or more tasks for the one or more client devices 104 using a dynamic programming technique, based on the determined usage-related information and the prioritized one or more client requests.

In an embodiment, the system 110 may monitor dynamically, the usage-related information of the one or more servers 116. In an embodiment, the system 110 may migrate from a first server to a second server of the one or more servers 116, the one or more tasks using at least one of a round-robin technique and graph theory technique, based on the monitored usage-related information. In an embodiment, the first server may be executing the one or more tasks for the one or more client devices 104. In an embodiment, the graph theory includes K-colour set problem technique which is used for task scheduling. In an embodiment, the round-robin technique may be used for time-based server utilization, based on a round-robin time scheduler report provided by the round-robin technique. In an embodiment, the round-robin technique and the dynamic programming technique may be used to prioritize Service Level Agreements (SLA) requirements of the one or more client devices 104. The scheduling one or more tasks is performed initially using the dynamic programming approach, and from the second round, for scheduling one or more tasks a Round Robin time scheduler report may be considered. The Round Robin approach may be used for updating time-based server utilization for a dynamic scheduler to avoid skewness.

In an embodiment, the system 110 may initiate the one or more tasks on the second server, in response to migrating the one or more tasks. In an embodiment, initiating the one or more tasks on the second server is to balance a load for resource utilization of the first server and the second server.

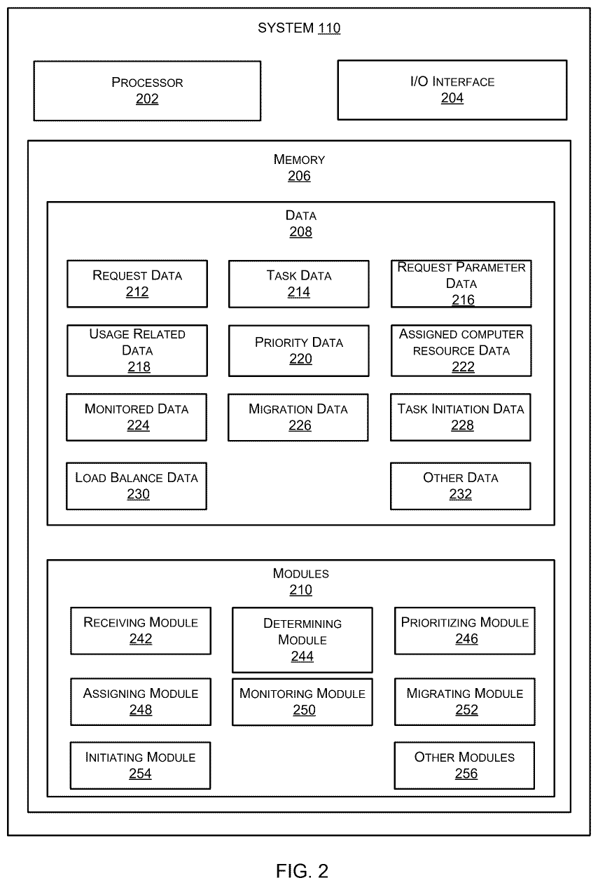

FIG. 2 illustrates a detailed block diagram representation of the system 110 for priority-based resource scheduling with load balancing, in accordance with an embodiment of the present disclosure. The system 110 may include a processor 202, an Input/Output (I/O) interface 204, and a memory 206. In some implementations, the system 110 may include data 208 and modules 210. As an example, the data 208 is stored in the memory 206 configured in the system 110 as shown in the FIG. 2.

In one embodiment, the data 208 may include request data 212, task data 214, request parameter data 216, usage related data 218, priority data 220, assigned computer resource data 222, monitored data 224, migration data 226, task initiation data 228, load balance data 230, and other data 232. In an embodiment, the data 208 may be stored in the memory 206 in the form of various data structures. Additionally, the data 208 can be organized using data models, such as relational or hierarchical data models. The other data 232 may store data, including temporary data and temporary files, generated by the modules 210 for performing the various functions of the system 110.

In an embodiment, the data 208 stored in the memory 206 may be processed by the modules 210 of the system 110. The modules 210 may be stored within the memory 206. In an example, the modules 206 communicatively coupled to a processor 202 configured in the system 110, may also be present outside the memory 206 as shown in FIG. 2 and implemented as hardware. As used herein, the term modules refer to an application-specific integrated circuit (ASIC), an electronic circuit, a processor (shared, dedicated, or group) and memory that execute one or more software or firmware programs, a combinational logic circuit, and/or other suitable components that provide the described functionality.

In an embodiment, the modules 210 may include, for example, a receiving module 242, a determining module 244, a prioritizing module 246, an assigning module 248, a monitoring module 250, a migrating module 252, an initiating module 254, and other modules 256. The other modules 256 may be used to perform various miscellaneous functionalities of the system 110. It will be appreciated that such aforementioned modules 210 may be represented as a single module or a combination of different modules.

In an embodiment, the receiving module 242 may receive, from a plurality of client devices 104, one or more client requests to execute one or more tasks on one or more servers 116 associated with one or more Virtual Machines (VMs). The one or more client requests may be stored as the request data 212. The one or more tasks to be executed may be stored as the task data 214. In an embodiment, the one or more client requests include request parameters. The request parameters include, but are not limited to, a demand comprising several tasks, a timeline, a pricing category, a Service Level Agreements (SLAs), and the like. The request parameters may be stored as the request parameter data 216.

In an embodiment, the determining module 244 may determine usage-related information of each server 116 associated with one or more VMs, upon receiving the one or more client requests. The usage-related information may be stored as the usage related data 218. The usage-related information includes, but is not limited to, an active time, a running time, a load level, and the like. Further, the usage-related information may also include, utilization data, expenditure report data for resource reservation/activation, computing resource consumption metric data, activation request data, functional grouping data, topological or relationship data, tagging data, or other metadata. The utilization data, may include, for example, historical data related to usage or activation of cloud computing resources, e.g., resource allocation history, activation/reservation/committed-use history data, expenditure report data for resource reservation/activation/committed-use, processor activity, memory usage history, computing cycles, data throughput, or other utilization metrics, seasonal usage cycles. The seasonal usage cycles may include, for example, holiday schedules, daily usage cycles, weekly usage cycles, quarterly usage cycles, or other data. The tagging data may include computing resource specific data. For example, tagging data may include data provided by an operator, provisioning or configuration management system, or an analysed system detailing functional groupings (e.g., project-specific allocations, hardware (including virtualized hardware) marked for a specific purpose, availability zones, operating systems), quality of service requirements, minimum allocations, or other tagging data. Further, the consumption metric data may include computing resource-specific cost metrics such as expenditure-per-time or resource-per-time metrics.

In an embodiment, the prioritizing module 246 may prioritize the received one or more client requests, based on the request parameters associated with the one or more client requests. The prioritized one or more client requests may be stored as the priority data 220. In an embodiment, the assigning module 248 may assign computing resources in the one or more servers 116 to execute the one or more tasks for the one or more client devices 104 using a dynamic programming technique, based on the determined usage-related information and the prioritized one or more client requests. The assigned computing resources in the one or more servers 116 may be stored as the assigned computer resource data 222.

In an embodiment, the monitoring module 250 may dynamically monitor, the usage-related information of the one or more servers 116. The monitored usage related information may be stored as the monitored data 224. In an embodiment, the migrating module 252 may migrate from a first server to a second server of the one or more servers 116, the one or more tasks using at least one of a round-robin technique and graph theory technique, based on the monitored usage-related information. The migrated one or more tasks may be stored as the migration data 226. In an embodiment, the first server may be executing the one or more tasks for the one or more client devices 104. In an embodiment, the graph theory includes K-colour set problem technique which is used for task scheduling. In an embodiment, the round-robin technique may be used for time-based server utilization, based on a round-robin time scheduler report provided by the round-robin technique. In an embodiment, the round-robin technique and the dynamic programming technique may be used to prioritize Service Level Agreements (SLA) requirements of the one or more client devices 104.

In an embodiment, the initiating module 254 may initiate the one or more tasks on the second server, in response to migrating the one or more tasks. The initiated one or more tasks may be stored as the task initiation data 228. In an embodiment, initiating the one or more tasks on the second server is to balance a load for resource utilization of the first server and the second server. The balanced load for resource utilization may be stored as the load balance data 230.

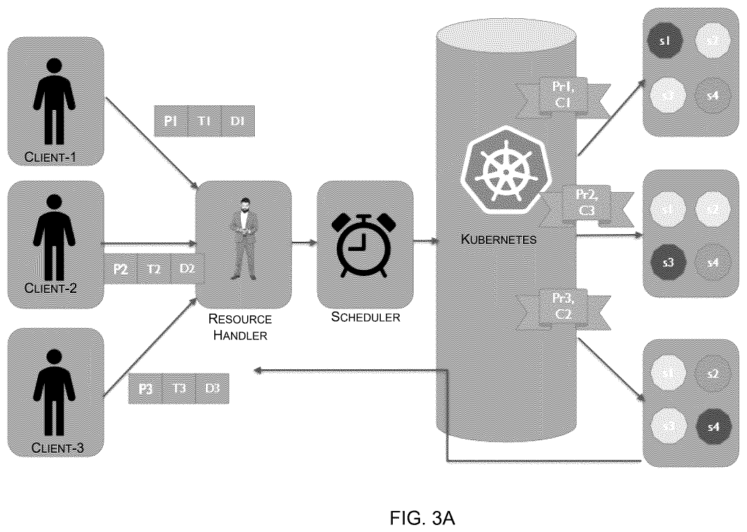

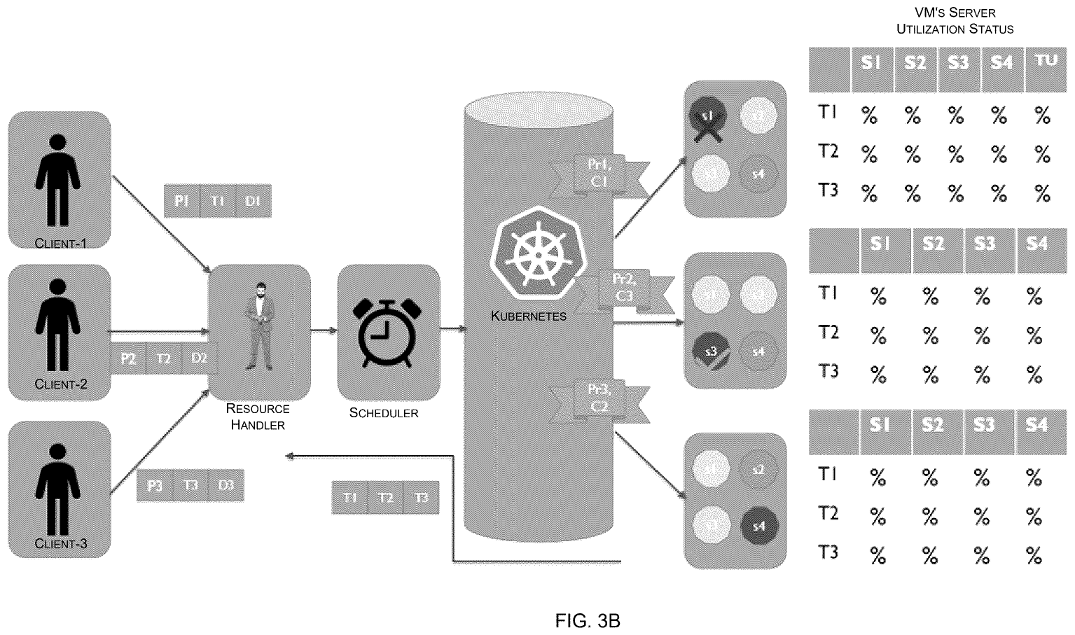

FIG. 3A illustrates a flow diagram representation of a client-server interaction for priority-based resource scheduling with load balancing, in accordance with an embodiment of the present disclosure.

Consider, client-1, client 2 and client 3 are client devices 104. The resource handler and the scheduler may be one or more modules in the system 110. Further, a platform, such as for example, but not limited to, Kubernetes® may managing containerized workloads and services, that facilitates both declarative configuration and automation of one or more servers 116 of the VMs. The VMs may include one or more servers 116. The client-1, client 2 and client 3 may provide one or more client requests to execute one or more tasks on one or more servers 116. The one or more client requests includes request parameters. The request parameters include demand (D) comprising several tasks, a timeline (T), a pricing category (P), and a Service Level Agreements (SLAs). For example, the one or more client requests may be prioritized based on the pricing (P) and time of completion (T). The resource handler may handle multiple VMs and the services at the same time to handle multiple client requests. The scheduler may schedule the one or more tasks to be executed on the one or more servers 116 of the VMs. The platform may provide priority (Pr1, Pr2, and Pr3) of the one or more client devices 104 (C1, C2, and C3) to the VMs.

The platform may monitor dynamically the usage-related information of the one or more servers 116 (S1, S2, S3, S4). Further, the platform may migrate from a first server to a second server of the one or more servers 116, the one or more tasks using at least one of a round-robin technique and graph theory technique, based on the monitored usage-related information. For example, the first server may be ‘S1’ which is executing the one or more tasks for the one or more client devices. Further, the platform may initiate the one or more tasks on the second server, in response to migrating the one or more tasks. For example, the second server may be ‘S2’. Further, based on the server availability for resources, the platform may assign a server, for example, S3, for Client 3 (C3), as shown in FIG. 3B. FIG. 3B illustrates a flow diagram representation of a utilization status of the server of Virtual Machine (VM), in accordance with an embodiment of the present disclosure. The T1, T2, and T3 are timelines, and S1, S2, and S3 are servers.

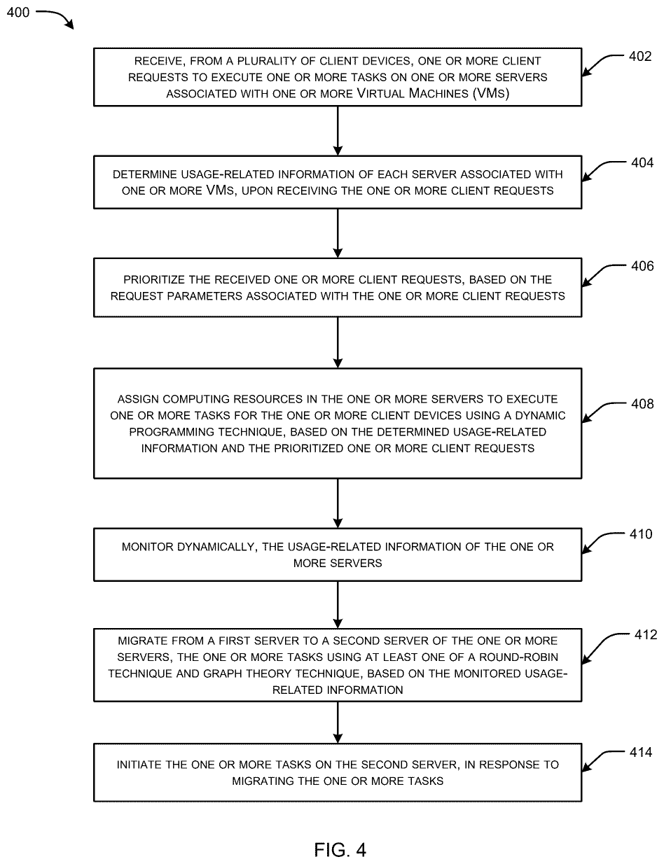

FIG. 4 illustrates a flow chart depicting a method 300 for priority-based resource scheduling with load balancing, in accordance with an embodiment of the present disclosure. As illustrated in FIG. 4, the method 400 includes one or more blocks illustrating a method of priority-based resource scheduling with load balancing. The method 400 may be described in the general context of computer-executable instructions. Generally, computer-executable instructions can include routines, programs, objects, components, data structures, procedures, modules, and functions, which perform functions or implement abstract data types.

The order in which the method 400 is described is not intended to be construed as a limitation, and any number of the described method blocks can be combined in any order to implement the method 400. Additionally, individual blocks may be deleted from the methods without departing from the spirit and scope of the subject matter described herein. Furthermore, the method 400 can be implemented in any suitable hardware, software, firmware, or combination thereof.

At block 402, the method 400 may include receiving, by the processor 202, from the plurality of client devices 104, one or more client requests to execute one or more tasks on one or more servers 116 associated with one or more Virtual Machines (VMs). The one or more client requests comprises request parameters.

At block 404, the method 400 may include determining, by the processor 202, usage-related information of each server 116 associated with one or more VMs, upon receiving the one or more client requests.

At block 406, the method 400 may include prioritizing, by the processor 202, the received one or more client requests, based on the request parameters associated with the one or more client requests.

At block 408, the method 400 may include assigning, by the processor 202, computing resources in the one or more servers to execute one or more tasks for the one or more client devices 104 using a mixed-integer programming technique, based on the determined usage-related information and the prioritized one or more client requests.

At block 410, the method 400 may include monitoring dynamically, by the processor 202, the usage-related information of the one or more servers 116.

At block 412, the method 400 may include migrating, by the processor 202, from a first server to a second server of the one or more servers 116, the one or more tasks using at least one of a round-robin technique and graph theory technique, based on the monitored usage-related information. The first server is executing the one or more tasks for the one or more client devices. 104.

At block 414, the method 400 may include initiating, by the processor 202, the one or more tasks on the second server, in response to migrating the one or more tasks.

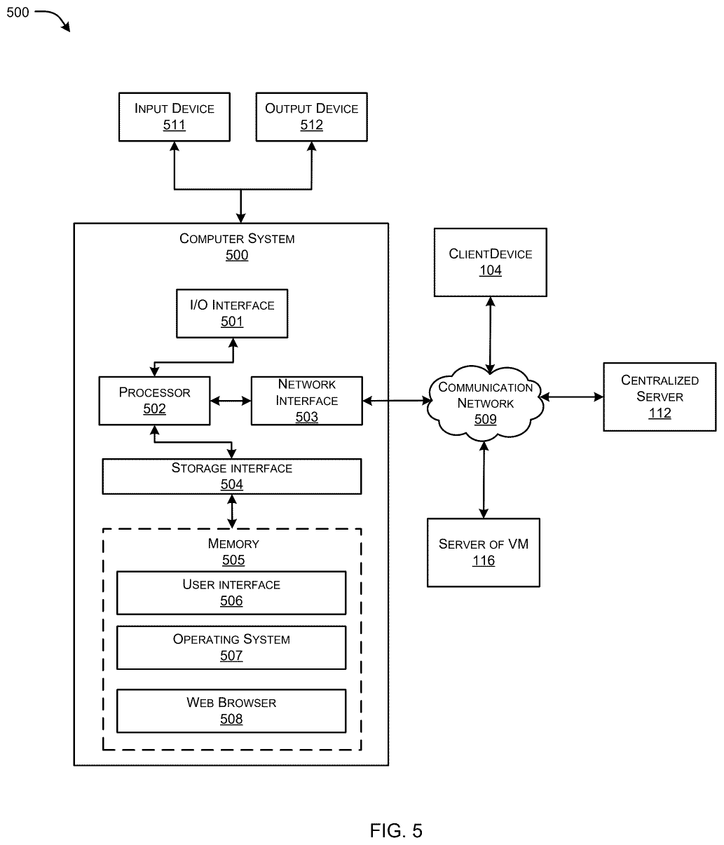

FIG. 5 illustrates an exemplary computer system in which or with which embodiments of the present invention can be utilized, in accordance with embodiments of the present disclosure.

In some embodiments, FIG. 5 illustrates a block diagram of an exemplary computer system 500 for implementing embodiments consistent with the present disclosure. In some embodiments, the computer system 500 can be a system 110 that is used for node-based bot processing automation, as shown in the FIG. 5. The computer system 500 may include a central processing unit (“CPU” or “processor”) 502. The processor 502 may include at least one data processor for executing program components for executing user or system-generated business processes. A user may include a person, a person using a device such as those included in this present disclosure, or such a device itself. The processor 502 may include specialized processing units such as integrated system (bus) controllers, memory management control units, floating-point units, graphics processing units, digital signal processing units, etc. The processor 502 may be disposed in communication with input devices 511 and output devices 512 via I/O interface 501. The I/O interface 501 may employ communication protocols/methods such as, without limitation, audio, analog, digital, stereo, IEEE-1395, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 501, computer system 500 may communicate with input devices 511 and output devices 512. In some embodiments, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 503 and the communication network 509, the computer system 500 may communicate with the one or more client devices 104, the one or more servers 116, and the centralized server 112. The computer system 500 may include at least one of, a mobile, a smartphone, a tablet, a phablet, a personal digital assistant, a computer, a laptop, a server, and the like. The computer system 500 may be associated with the one or more client devices 104, and/or the one or more servers 116. The processes of the one or more client devices 104, and/or the one or more servers 116 may be implemented on the computer system 500.

The communication network 509 can be implemented as one of the different types of networks, such as an intranet or Local Area Network (LAN) and such within the organization. The communication network 509 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 509 may include a variety of network devices, including routers, bridges, servers, computing devices, storage devices, etc. In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1395, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc. The memory 505 may store a collection of program or database components, including, without limitation, a user interface 506, an operating system 507, a web browser 508, etc. In some embodiments, the computer system 500 may store user/application data, such as the data, variables, records, etc. as described in this invention. Such databases may be implemented as fault-tolerant, relational, scalable, secure databases such as Oracle or Sybase. Operating system 507 may facilitate resource management and operation of the computer system 500. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® IOS©, GOOGLE™ ANDROID™, BLACKBERRY® OS, or the like. User interface 506 may facilitate display, execution, interaction, manipulation, or operation of program components through textual or graphical facilities. For example, user interfaces may provide computer interaction interface elements on a display system operatively connected to computer system 500, such as cursors, icons, checkboxes, menus, scrollers, windows, widgets, etc. Graphical User Interfaces (GUIs) may be employed, including, without limitation, Apple® Macintosh® operating systems' Aqua®, IBM® OS/2®, Microsoft® Windows® (e.g., Aero, Metro, etc.), web interface libraries (e.g., ActiveX®, Java®, Javascript®, AJAX, HTML, Adobe® Flash®, etc.), or the like.

Computer system 500 may implement a web browser 508 stored-program components. Web browser 508 may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers 508 may utilize facilities such as AJAX, DHTML, ADOBE® FLASH®, JAVASCRIPT®, JAVA®, Application Programming Interfaces (APIs), etc. Computer system 500 may implement a mail server stored program component. The mail server may be an Internet mail server such as Microsoft Exchange, or the like. The mail server may utilize facilities such as ASP, ACTIVEX®, ANSI® C++/C #, MICROSOFT®, NET, CGI SCRIPTS, JAVA©, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 500 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, etc. Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

As used herein, and unless the context dictates otherwise, the term “coupled to” is intended to include both direct coupling (in which two elements that are coupled to each other or in contact with each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

Moreover, in interpreting both the specification and the claims, all terms should be interpreted in the broadest possible manner consistent with the context. In particular, the terms “comprise” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While some embodiments of the present disclosure have been illustrated and described, those are completely exemplary in nature. The disclosure is not limited to the embodiments as elaborated herein only and it would be apparent to those skilled in the art that numerous modifications besides those already described are possible without departing from the inventive concepts herein. All such modifications, changes, variations, substitutions, and equivalents are completely within the scope of the present disclosure. The inventive subject matter, therefore, is not to be restricted except in the spirit of the appended claims.

1. A method for priority-based resource scheduling with load balancing, the method comprising:
receiving, by a processor (202) associated with a resource scheduling system (110), from a plurality of client devices (104), one or more client requests to execute one or more tasks on one or more servers (116) associated with one or more Virtual Machines (VMs), wherein the one or more client requests comprises request parameters;
determining, by the processor (202), usage-related information of each server associated with one or more VMs, upon receiving the one or more client requests;
prioritizing, by the processor (202), the received one or more client requests, based on the request parameters associated with the one or more client requests;
assigning, by the processor (202), computing resources in the one or more servers (116) to execute one or more tasks for the one or more client devices (104) using a dynamic programming technique, based on the determined usage-related information and the prioritized one or more client requests;
monitoring dynamically, by the processor (202), the usage-related information of the one or more servers (116);
migrating, by the processor (202), from a first server to a second server of the one or more servers (116), the one or more tasks using at least one of a round-robin technique and graph theory technique, based on the monitored usage-related information, wherein the first server is executing the one or more tasks for the one or more client devices (104); and
initiating, by the processor (202), the one or more tasks on the second server, in response to migrating the one or more tasks, wherein initiating the one or more tasks on the second server is to balance a load for resource utilization of the first server and the second server.

2. The method as claimed in claim 1, wherein the request parameters comprise at least one of a demand comprising several tasks, a timeline, a pricing category, and a Service Level Agreement (SLA).

3. The method as claimed in claim 1, wherein the usage-related information comprises at least one of an active time, a running time, and a load level.

4. The method as claimed in claim 1, wherein the graph theory comprises K-colour set problem technique which is used for task scheduling.

5. The method as claimed in claim 1, wherein the round-robin technique is used for time-based server utilization, is based on a round-robin time scheduler report provided by the round-robin technique.

6. The method as claimed in claim 1, wherein the round-robin technique and the dynamic programming technique is used to prioritize Service Level Agreement (SLA) requirements of the one or more client devices (104).

7. A resource scheduling system (110) for priority-based resource scheduling with load balancing, the method comprising:
a processor (202);
a memory (206) coupled to the processor (202), wherein the memory (206) comprises processor-executable instructions, which on execution causes the processor (202) to:
receive, from a plurality of client devices (104), one or more client requests to execute one or more tasks on one or more servers (116) associated with one or more Virtual Machines (VMs), wherein the one or more client requests comprises request parameters;
determine usage-related information of each server associated with one or more VMs, upon receiving the one or more client requests;
prioritize the received one or more client requests, based on the request parameters associated with the one or more client requests;
assign computing resources in the one or more servers (116) to execute one or more tasks for the one or more client devices (104) using a dynamic programming technique, based on the determined usage-related information and the prioritized one or more client requests;
monitor dynamically, the usage-related information of the one or more servers (116);
migrate from a first server to a second server of the one or more servers (116), the one or more tasks using at least one of a round-robin technique and graph theory technique, based on the monitored usage-related information, wherein the first server is executing the one or more tasks for the one or more client devices (104); and
initiate the one or more tasks on the second server, in response to migrating the one or more tasks, wherein initiating the one or more tasks on the second server is to balance a load for resource utilization of the first server and the second server.

8. The resource scheduling system (110) as claimed in claim 7, wherein the request parameters comprise at least one of a demand comprising several tasks, a timeline, a pricing category, and a Service Level Agreement (SLA).

9. The resource scheduling system (110) as claimed in claim 7, wherein the usage-related information comprises at least one of an active time, a running time, and a load level.

10. The resource scheduling system (110) as claimed in claim 7, wherein the graph theory comprises K-colour set problem technique which is used for task scheduling.

11. The resource scheduling system (110) as claimed in claim 7, wherein the round-robin technique is used for time-based server utilization, based on a round-robin time scheduler report provided by the round-robin technique.

12. The resource scheduling system (110) as claimed in claim 7, wherein the round-robin technique and the dynamic programming technique is used to prioritize Service Level Agreement (SLA) requirements of the one or more client devices (104).

13. A system for priority-based resource scheduling with load balancing, comprising:
an input port configured to receive requests to execute one or more tasks;
at least one automated processor (202) associated with a resource scheduling system (110), configured to:
receive from a plurality of client devices (104), one or more client requests to execute one or more tasks on one or more servers (116) associated with one or more Virtual Machines (VMs), wherein the one or more client requests comprises request parameters;
determine usage-related information of each server associated with one or more VMs, upon receiving the one or more client requests;
prioritize the received one or more client requests, based on the request parameters associated with the one or more client requests;
assign computing resources in the one or more servers (116) to execute one or more tasks for the one or more client devices (104) using a dynamic programming technique, based on the determined usage-related information and the prioritized one or more client requests;
dynamically monitor the usage-related information of the one or more servers (116);
migrate the one or more tasks from a first server to a second server of the one or more servers (116) using at least one of a round-robin technique and graph theory technique, based on the monitored usage-related information, wherein the first server executes the one or more tasks for the one or more client devices (104); and
initiate the one or more tasks on the second server, in response to migrating the one or more tasks, wherein the one or more tasks are initiated on the second server to balance a load for resource utilization of the first server and the second server; and
an output port configured communicate control information the first server and the second server.

14. The system as claimed in claim 13, wherein the at least one automated processor is configured to migrate the one or more tasks from a first server to a second server of the one or more servers (116) using a round-robin technique.

15. The system as claimed in claim 13, wherein the at least one automated processor is configured to migrate the one or more tasks from a first server to a second server of the one or more servers (116) a graph theory technique.

16. The system as claimed in claim 13, wherein the request parameters comprise at least one of a demand comprising several tasks, a timeline, a pricing category, and a Service Level Agreement (SLA).

17. The system as claimed in claim 13, wherein the usage-related information comprises at least one of an active time, a running time, and a load level.

18. The system as claimed in claim 13, wherein the graph theory comprises K-colour set problem technique which is used for task scheduling.

19. The system as claimed in claim 13, wherein the round-robin technique is used for time-based server utilization, is based on a round-robin time scheduler report provided by the round-robin technique.

20. The system as claimed in claim 13, wherein the round-robin technique and the dynamic programming technique is used to prioritize Service Level Agreement (SLA) requirements of the one or more client devices (104).
